(19) United States
(12) Patent Application Publication
(10) Pub. No.: US 2013/0146437 A1
(43) Pub. Date: Jun. 13, 2013

(54) DEHUMIDIFIER SYSTEM AND METHOD

(71) Applicant: Lockheed Martin Corporation, Bethesda, MD (US)

(72) Inventors: Scott M. MAURER, Haymarket, VA (US); Michael R. ELLER, New Orleans, LA (US); Nicholas J. NAGURNY, Manassas, VA (US)

(73) Assignee: LOCKHEED MARTIN CORPORATION, Bethesda, MD (US)

(21) Appl. No.: 13/683,534

(22) Filed: Nov. 21, 2012

Related U.S. Application Data
(60) Provisional application No. 61/563,422, filed on Nov. 23, 2011.

(51) Int. Cl. F28F 1/10; F03G 7/06; C02F 1/04; F17D 1/00

(52) U.S. Cl. CPC F28F 1/10; F17D 1/00; F03G 7/06; C02F 1/04
USPC 202/185.1; 165/177; 165/181; 165/185; 137/561 R; 60/641.7; 210/180

(57) ABSTRACT

A condenser or heat exchanger includes a circulation system for moving a cooling fluid, and a graphite foam in thermal communication with the circulation system. The condenser or heat exchanger can be used to remove water, or more particularly freshwater from humid air in tropical, subtropical, and arid climates.

### TECHNICAL FIELD

Various embodiments described herein relate to a dehumidifier system and method. The dehumidifier system and method is used to produce a source of fresh water for human consumption.

### BACKGROUND

An increase in worldwide population has led to the increase in demand for fresh water for human consumption and irrigation. Over 99% of the world's fresh water comes from tapping a diminishing source of the world's rivers, lakes, and groundwater locations that are becoming less dependable as some are reaching maximum capacities. With only 1% of the world's water supply available for human use in a constantly expanding worldwide population, clean water is becoming the most important commodity in water-stressed regions. The increase in demand for fresh water has been most evident in dry areas where rainwater is scarce and groundwater sources are drying up such as: the Middle East, Australia, and the American West and Southwest, to name a few.

Clean water is necessary for irrigation in arid regions where occupants rely on importing most of their food because agriculture is too expensive or not possible. Although clean water is basic utility in water-rich and developed regions, the arid and less developed regions of the world do not have access to clean water.

Most of the earth's surface, about 71%, is covered with water. However, most of the water is in saltwater oceans. Of course, salt water is unfit for human consumption. Water can be desalinated. The two most common options for water production include non-thermal/pressure/membrane processes, and thermal processes. The non-thermal/pressure/membrane processes include reverse osmosis (“RO”), filtration, sludge, and the like. The thermal processes include multi-stage flash, multi-effect distillation, and low-temp thermal desalination. Generally, water treatment and desalination methods require capital intensive equipment and facilities that become more expensive in regions that are arid and underdeveloped.

When there is not enough fresh potable water, some people resort to drinking water from polluted sources. Consumption of polluted water affects the health of approximately 1.2 billion people and contributes to 5 million deaths each year from water-related diseases such as cholera, schistosomiasis, and malaria.

### BRIEF DESCRIPTION OF THE DRAWINGS

FIG. 1 is a schematic view of a humidification dehumidification (“HDH”) cycle, according to an example embodiment.

FIG. 2 is a schematic view of a dewvapor system, according to an example embodiment.

FIG. 3 is a schematic view of a Seawater Greenhouse that utilizes an HDH cycle having a condenser with graphite foam, according to an example embodiment.

FIG. 4 is a perspective view of a condenser that is used in the seawater greenhouse, according to an example embodiment.

FIG. 5 is a cross section view of a portion of the condenser 420 shown in FIG. 4, according to an example embodiment.

FIG. 6 is a Pyschrometric Chart showing the average dewpoint temperatures in Honolulu, Hawaii and Haiti.

FIG. 7 is a Pyschrometric Chart showing the average dewpoint temperatures in Aruba, one of the Dutch Antille Islands.

FIG. 8 is a graph showing the seawater thermocline temperature profile found across most of the tropical regions where dewpoint dehumidification would be possible.

FIG. 9 shows another condenser made with graphite foam, according to an example embodiment.

FIG. 10 is another schematic diagram of a OTEC system, according to an example embodiment.

FIG. 11 is a perspective view of a commercial chiller and air conditioning unit, that can be used as a source to cool and condense water from the air in an environment, according to an example embodiment.

FIG. 12 is a perspective view an enhanced shell and tube design in which FSW is used to join round tubes to a first tubesheet at one end and a second tubesheet at another end, according to an example embodiment.

### DETAILED DESCRIPTION

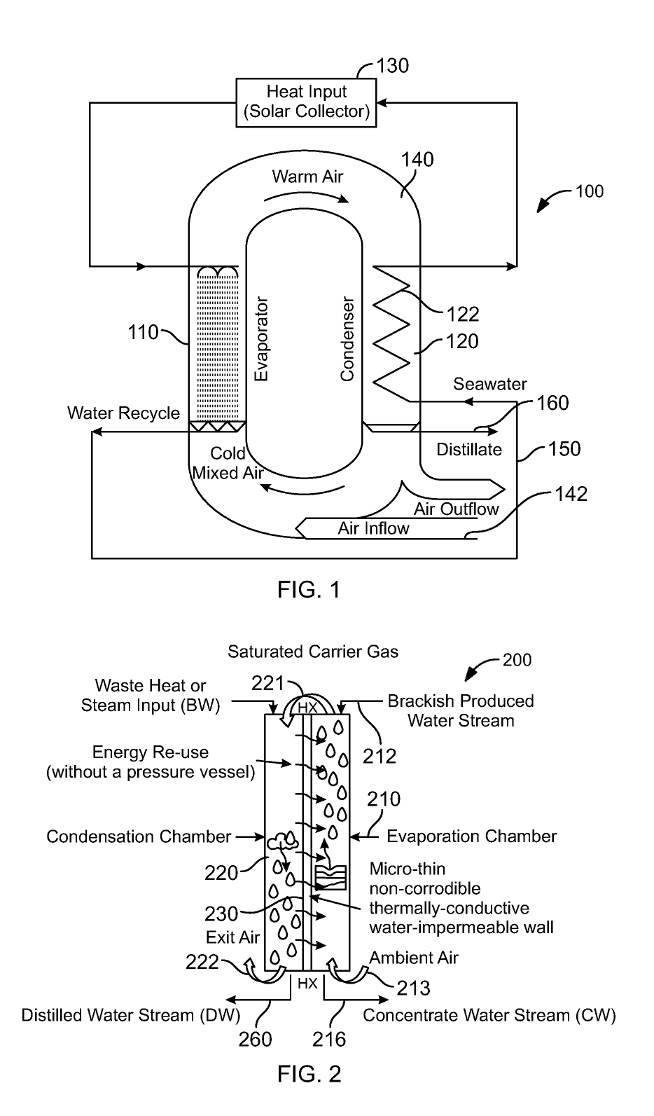

FIG. 1 is a schematic view of a humidification dehumidification (“HDH”) cycle 100 used to desalinate water, according to an example embodiment. The humidification dehumidification cycle includes an evaporator 110, a condenser 120, a solar collector 130, a system for containing and moving air 140, and a plumbing system 150 for moving seawater. The system for containing and moving air 140 includes an air intake 142. The air is ambient air from the environment. Some air is very dry, such as when the humidification dehumidification cycle 100 is located in an arid area. Some air is more moist or humid and carries more water vapor in the ambient area, such as when the humidification dehumidification cycle 100 is located in a tropical area, such as Hawaii, Aruba, or the like. At the evaporator 110, the ambient air is charged or provided with more water content. In this particular embodiment, the water source used is seawater or salt water. The seawater or saltwater is heated for higher evaporation and higher water content in the air vapor stream. The heated seawater or saltwater is vaporized in the evaporator 110 in any number of ways. For example, the seawater or saltwater can be placed in a mister or similar device so that air passing the evaporator 110 picks up additional moisture. In another embodiment, the seawater or saltwater can be heated to produce steam which can be input into the stream of air. In tropical climates, the ambient air and the additional liquid presented at the evaporator 110 contains salt. The moist or humid air (without salt) is moved past the evaporator 110 to the condenser 120.

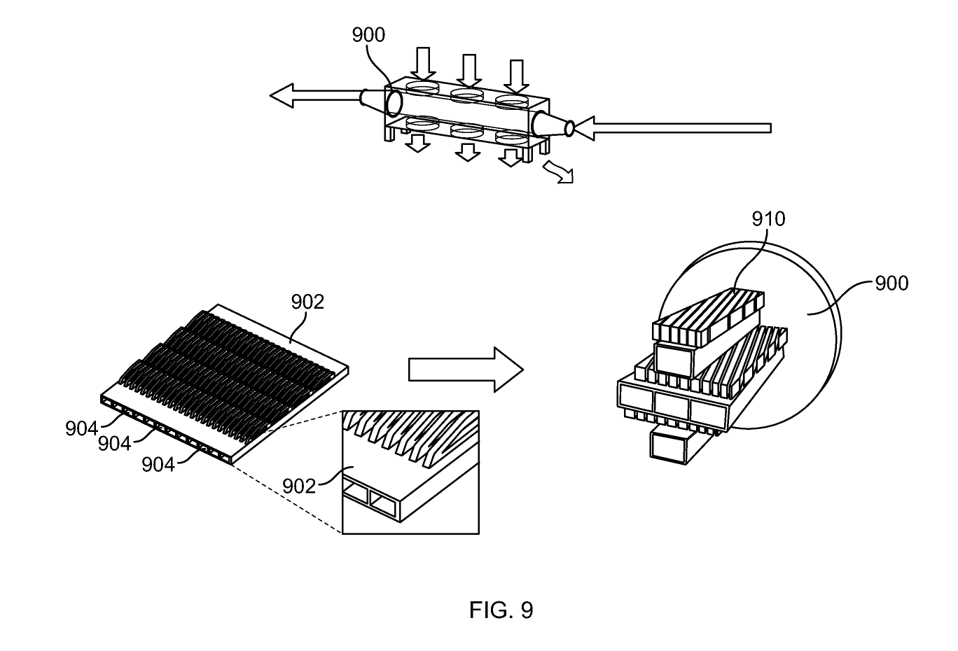

The condenser 120 includes a cool fluid circulation system 122 which is an arrangement of tubing, fins or plates. In thermal communication with the tubing or the fluid circulation system 122 are a number of fins. The fins (shown in FIG. 9) that are also cooled by the cool fluid circulating in the fluid circulation system 122. The moisture in the humid air condenses onto the fins, when it contacts the cool fins or cool material that makes up the fins of the condenser. The condensate or distillate from the fins is fresh or desalinated water which is fit for human consumption or fit for using to irrigate plants. Of course, in some instances the desalinated water may have to be further processed to remove undesirable components and add other desirable components.

The cool fluid passing through the fluid circulation system 122 in the condenser 120 can be any source of cool fluid. In one embodiment, the cool fluid could be a refrigerant. In another embodiment, the cool fluid could be seawater pulled up from a location deep in the ocean. The temperature of seawater pulled up from below the thermocline in the sea near a tropical island, for example, can be in the range of 5 to 15 degrees Celsius, depending on the depth from which the water is drawn. As the water passes through the recirculation system 122 of the condenser 120, the cool fluid cools the condenser 120 and more specifically the fins attached to the recirculation system 122. As will be described in more detail below, the fins can include a graphite foam, metal foam or metal fins. The graphite foam has a large surface area. The large surface area is also cooled by the cool fluid. The large surface area formed provides or presents a larger area onto which water vapor in the air can condense. As a result, more desalinated water is produced when compared to using other tubes or smaller surface area fin structures. The desalinated water is output from the system as distillate 160.

The cool fluid picks up heat as it passes through the condenser 120. The fluid is further heated at the solar collector 130 and moved onto the evaporator 110. The warmer the fluid at the evaporator, the higher the humidity ratio (amount of water in the air) at the evaporator 110. Warmer air also holds a larger amount of water vapor when compared to the same amount of cooler air. In other words, the warmer the air coming from the evaporator 110 and heading to the condenser 120, the more moisture it holds and the more that can be condensed in the condenser 120.

One of the prevailing uses of the HDH cycles is dew-vaporation. FIG. 2 is a schematic view of an apparatus 200 that utilizes the dew-vaporation cycle. As an overview, the dew-vaporation cycle uses multiple stages of humidifiers and dehumidifiers to treat wastewater or desalinate water and return a distilled water product 260. The dewvaporation apparatus 200 is a continuous contacting apparatus for separating a liquid component from a liquid mixture. The apparatus 200 includes an evaporation chamber 210 having first end 211 and a second end 212, an inlet 213 for a carrier gas and an outlet 214 for a carrier gas, and an inlet 215 for a liquid mixture, and an outlet 216 for a liquid mixture. The outlet 216 for the liquid mixture and the inlet 213 of the carrier gas are located on the first end 211 of the evaporation chamber. The apparatus 200 also has a dew-formation chamber 220 having an inlet 221 and an outlet 222 for a carrier gas, and an outlet 260 for the separable liquid component. In the dew formation chamber or condenser 220, the inlet 221 for the carrier gas of the dew-formation chamber 220 is situated in a countercurrent manner to the inlet 211 for the carrier gas of the evaporation chamber 210. The apparatus 200 also includes a common heat transfer wall 230 capable of providing thermal communication between the evaporation chamber 210 and the dew-formation chamber 220. The apparatus 200 can also include a feeding device for providing the liquid mixture onto the evaporation side 210 of the heat transfer wall 230, an air handler moving the carrier gas through the evaporization chamber 210 and the dew-formation chamber 220, and a heating apparatus for heating the carrier gas from the outlet 214 of the evaporation chamber 210, wherein the heated carrier gas is directed to flow into the inlet 221 of the dew-formation chamber 220. The feeding device can be any device that allows feeding of the liquid mixture to the apparatus 200 and specifically to the evaporization chamber 210. Examples include a pump, and a liquid mixture tank placed above the apparatus to allow gravity feeding of the liquid mixture into the apparatus 200. Heat from condensation of the separable component in the dew-formation chamber 220 is communicated across the heat transfer wall 230, to allow the separable component to evaporate into the carrier gas in the evaporation chamber 210. Thermal communication, as used herein, means that heat can flow between the communicating components.

In the condenser 120 of the dehumidification apparatus 100 and in the dew-formation chamber 220 of the dewvaporation device 200, graphite foam, metal foam or metal fins is used as part of the fins to provide increased surface area onto which water can condense. In one embodiment, the dehumidifier in the condenser section of the cycle will utilize multi-channel extrusions constructed from either plastic such as polyethylene or metal such as aluminum. Graphite foam fins are applied to the exterior of the multi-channel extrusions. Thermally conductive adhesive is used to bond the graphite foam to the fins or tubes in the condensers. For example, in the condenser of the dewvaporization apparatus 200, the graphite foam is bonded to polypropylene sheets using a thermally conductive epoxy such as Aremco 568 to ensure that dew could not find any dry zones in the graphite foam channel. The graphite foam is a low-cost, high thermal conductivity performance material. Multi-channel extrusions having graphite foam attached or bonded thereto utilize a water-to-air exchange with little to no pressure involved. Since little or no pressure is involved, the dehumidifier 100 described uses normal atmospheric air as a heat medium to convert seawater to freshwater.

In the dewvaporation apparatus, the evaporization chamber 210 can also use the graphite foam. The graphite foam is positioned at the entrance of the vaporization chamber and specifically at the entrance of the channels into the vaporization chamber. The graphite foam is used to distribute liquid more evenly into the top of the structure. The graphite foam is stable through a wide range of temperatues and can withstand elevated temperatures which can be used to increase the amount of fluid or water vapor placed into the air. In addition, the graphite foam promotes better fluid distribution and better heat transfer.

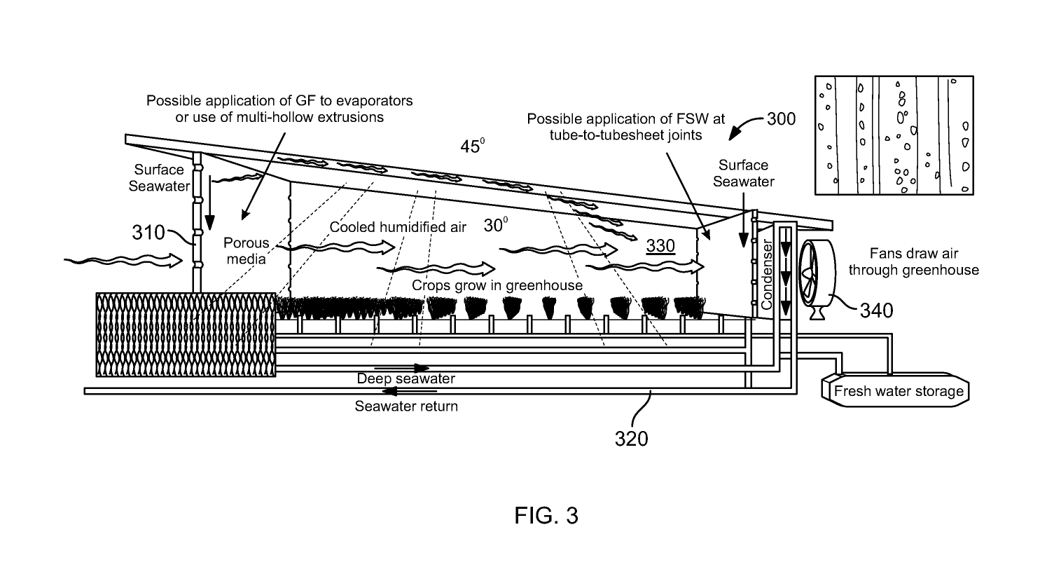

FIG. 3 is a schematic view of a Seawater Greenhouse 300 that utilizes an HDH cycle having a condenser with graphite foam, according to an example embodiment. The Seawater Greenhouse 300 is another embodiment of a desalination system particularly developed for arid regions with less humidity in the air than tropical and subtropical regions. It should be noted that in this example embodiment, the greenhouse is creating the humidity for condensation in an arid region. This example shows that this invention is not just limited to tropical and subtropcial regions, but can be extended to arid regions of the world. The Seawater Greenhouse 300 uses the HDH concept described above to produce fresh water using seawater to humidify and dehumidify air within a greenhouse while growing crops. The Seawater Greenhouse 300 includes an evaporator 310 and a condenser 320. The evaporator 310 includes an air intake in which the incoming air flows over cardboard “evaporator grilles” wetted with seawater. The incoming air picks up additional moisture and is cooled in the process as it is placed into a main greenhouse 330 where plants are being grown. The sun heats the air while in the greenhouse 330 using the greenhouse effect. Deep seawater, such as seawater from below the thermocline, provides a cool liquid piped through the condenser to cool the tubes surfaces of the condenser 320. More particularly, the deep seawater is flowed through polyethylene condenser tubes to condense humid air into fresh water. Fins having graphite foam attached using a thermal adhesive present a cool surface onto which moisture from the moist air moving out of the greenhouse 330 condenses. The condensed moisture is freshwater that is suitable for irrigation or for drinking. Of course, if the condensed water is to be used for drinking, it may undergo additional treatment such as filtering to remove solids or other treatments. An air handler 340 can be used to move air through the evaporator 310, the main greenhouse 330, and the condenser 320. In one embodiment, the air handler 340 is a fan that draws air through the evaporator 310, the main greenhouse 330, and the condenser 320. It should be noted that the designs that pull or condense water from air, are typically referred to as Atmospheric Water Generators (AWGs).

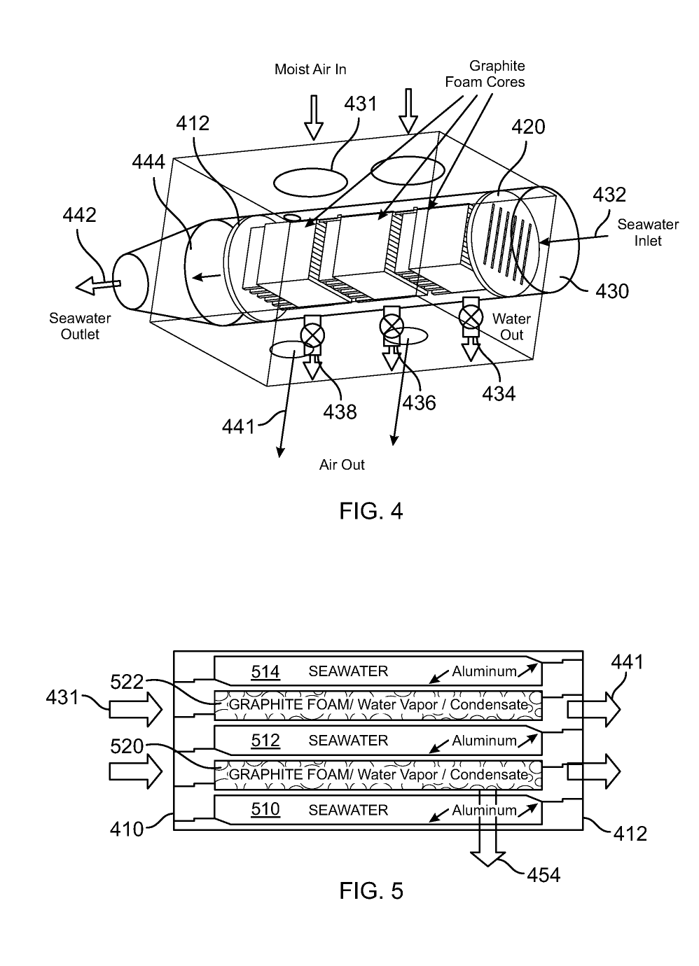

FIG. 4 is a perspective view of a condenser 420 that could be used in the seawater greenhouse 300, according to an example embodiment. FIG. 5 is a cross section view of a portion of the condenser 420 shown in FIG. 4, according to an example embodiment. Now referring to both FIGS. 4 and 5, the condenser 420 will be discussed in more detail.

The condenser 420 is a highly efficient Graphite Foam Heat Exchanger (GFHX) using a hybrid heat exchanger (HX) in a shell & plate-fin configuration. The condenser 420 includes a first plate 410 and a second plate 412. The first plate 410 includes openings for various tubes that will be attached to the openings. Similarly, the second plate 412 includes openings for various tubes that will be attached to the openings. The first plate 410 corresponds to one end of a tube and the second plate 412 corresponds to the other end of the tube attached between the first plate 410 and the second plate 412. Graphite foam surrounds the tubes between the two plates. The graphite foam is in thermal communication with the tubes as shown in FIG. 5. FIG. 5 shows three tubes 510, 512, 514 through which seawater is passed. As shown in FIG. 5, the tubes 510, 512, 514 are made of aluminum, in one example embodiment. In most embodiments, the material used is corrosion resistant so that the structure will last for a long time. Seawater is very corrosive when it contacts steel material. The graphite foam material 520, 522 is sandwiched between the tubes 510, 512, 514 and isolated from the seawater. The graphite material replaces the tubes and metal fin material. It should be noted that in a design there are generally many more tubes than the three shown in FIG. 5. Note, there are numerous openings in the first plate 410 of FIG. 4 and each one will generally have a corresponding tube. The graphite material generally has more surface area than the fins and is more thermally conductive, so the heat transfer capability of the resulting structure is enhanced when compared to a condenser that has only fins. In another embodiment, fins are attached to the tubes 510, 512, 514 and the graphite foam is bonded to the fins to provide increased surface area and increased heat transfer for the tubes.

A structure 420 formed by the first plate 410 and the second plate 412, the tubes and the graphite material is placed in a shell 430. The shell 430 has an air inlet 431, a seawater inlet 432 at one end and an air outlet 441 and a seawater outlet 442 at the other end. Water that is condensed on the graphite foam passes out outlet opening 434 of the shell 430. It should be noted that the shell can be made of any material. In low pressure systems, the shell does not have to be a pressure vessel and can be made out of less expensive materials, such as fiberglass. Of course, the structure 420 must fit tightly to the shell 430 so as to prevent a bypass condition where the incoming air does not pass down the tubes, such as tubes 510, 512, 514, in the structure 420.

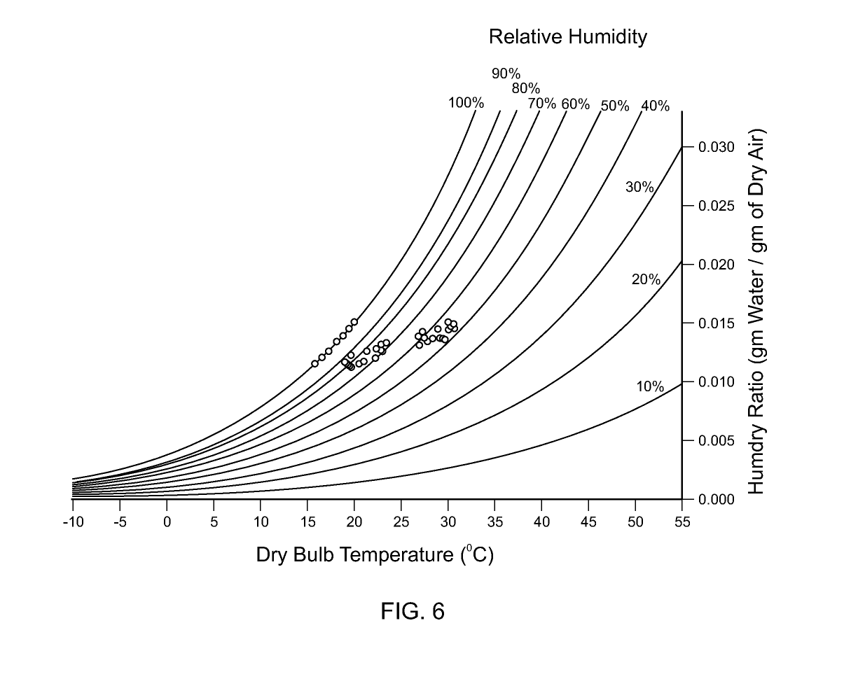

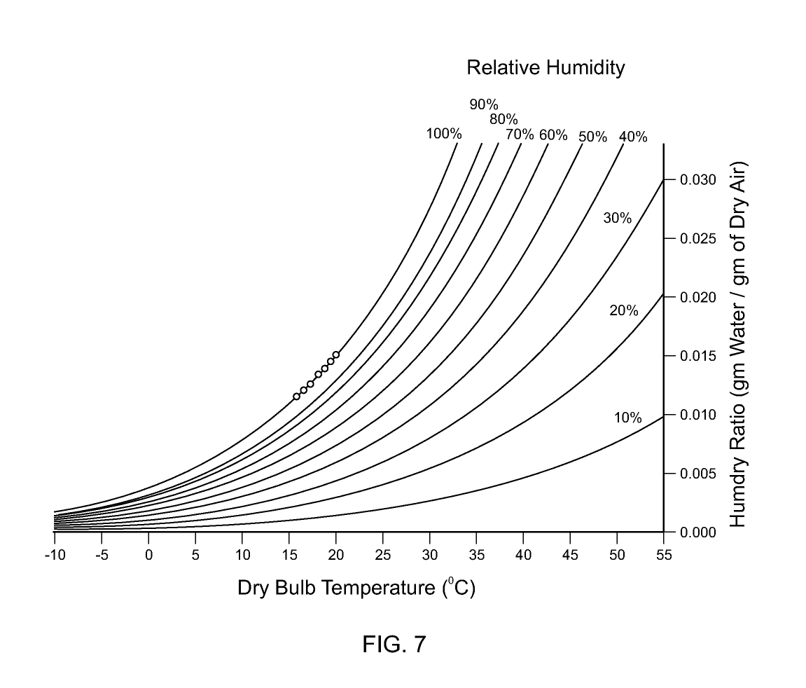

In one embodiment, the condenser 420 can be used to condense moisture from atmospheric air masses in tropical locations, such as Hawaii or Aruba (one of the Dutch Antilles Islands). FIG. 6 is a Pyschrometric Chart showing the average dewpoint temperatures in Honolulu, Hawaii and Haiti. It can be seen that the average minimum dewpoint where condensation occurs is 59 degrees Fahrenheit or 15 degrees Celsius. FIG. 7 is a Pyschrometric Chart showing the average dewpoint temperatures in Aruba. It can be seen that the average minimum dewpoint where condensation occurs is 68 degrees Fahrenheit or 20 degrees Celsius. These example regions show that only a minimum value of 15° C. (below the average dewpoint) is required to sufficiently condense large amounts of tropical air into freshwater in areas such as Hawaii and Haiti. In island and coastal regions such as those off Africa, India or Aruba in the trade-winds belt, this minimum value increases to 20° C., thereby making the effort to produce water per kW even more attractive. These devices can also be implemented in Florida or other coastal regions anywhere in the world that have an atomosphere with ambient conditions featuring a high dewpoint and a high temperature for all or part of the year.

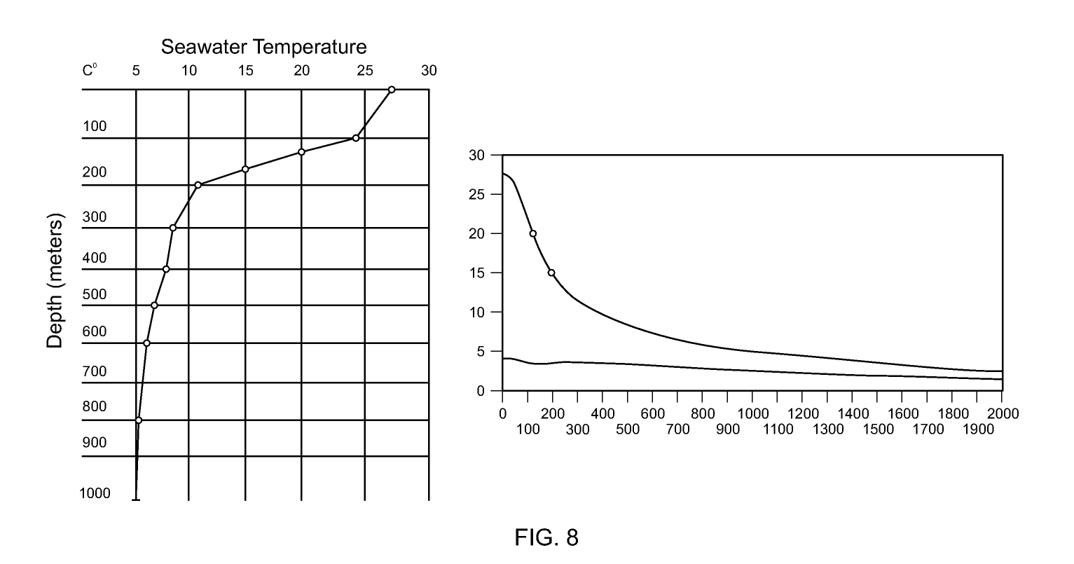

Each of these islands (Hawaii, Haiti, Aruba) has access to deep seawater that can be pumped from a depth to cool the condensing surface, like the graphite foam, to the dewpoint where freshwater will condense from the atmospheric air. FIG. 8 is a graph showing the seawater thermocline temperature profile found across most of the tropical regions where dewpoint dehumidification would be possible. For those regions requiring a 15° C. temperature for condensation, a Cold Water Pipe (CWP) of 200 m depth is required. These CWPs could be angled off the coast or in a vertical orientation if desirable. For those regions requiring 20° C. for dewpoint condensation, a CWP of only 125 m in depth is required making the necessary deep sea water easier to obtain.

FIG. 9 shows a portion of another condenser 900 or graphite foam heat exchanger (GFHX) made with graphite foam, according to an example embodiment. FIG. 9 shows two possible condenser portions which would fit inside the condenser 900. The condenser 900 could have an enhanced Shell & Tube configuration 950 or the Hybrid, Shell & Plate or Plate 910 configuration. The GFHX 900 includes low-cost, marine grade Aluminum alloy extrusions with the foam bonded to the multi-hollow tubes 904. This creates a hybrid (Shell & Plate) GFHX that is very efficient and inexpensive to build. The low-pressure shell (not shown but similar to that shown in FIG. 4) required enables the use of inexpensive composites and fiberglass materials as the shell materials. A thermally conductive epoxy bonds the aluminum 902, the graphite foam 910 and Multi-hollow extruded (MHE) tube. Joining by use of brazing techniques can be used as an alternative to epoxy bonding, in one example embodiment. Of course, other forms of bonding or thermally coupling the aluminum, graphite foam and the MHE are also contemplated. The corrosion points that stem from brazing in such a device are also avoided but could also be implemented in fabrication processes. Bonding allows the use of marine grade aluminum alloys such as 5xxx or 6xxx aluminum alloys to be used and allows the material strength of these metals to be maintained. A hybrid, shell and plate-fin or enhanced tube construction is a relatively simple to manufacture technique. Furthermore, the use of Friction Stir Welding (FSW) on tube sheet ends can save construction cost and reduce corrosion, and use of graphite foam enhances heat transfer and resulting water (condensate production). The heat transfer and resulting water production may result in reduced size of condensers. In addition, the cost in dollars per unit of water produced is also reduced.

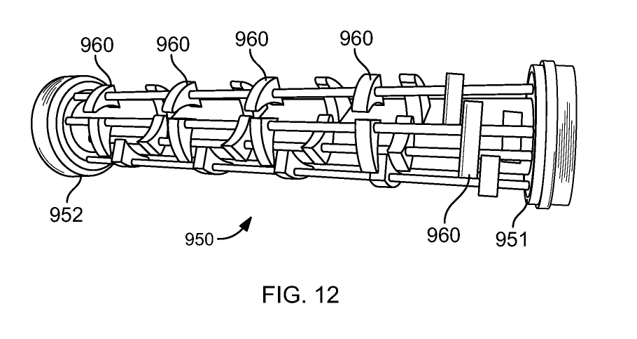

FIG. 12 also shows an enhanced shell and tube design 950 in which FSW is used to join round tubes to a first tubesheet 951 at one end and a second tubesheet 952 at another end. FSW is used to prevent or substantially limit corrosion. Graphite foam 960 is attached to the round tubes carrying the cool seawater. The graphite foam is in the form of strips 960 which are attached transverse to the tubes carrying the seawater.

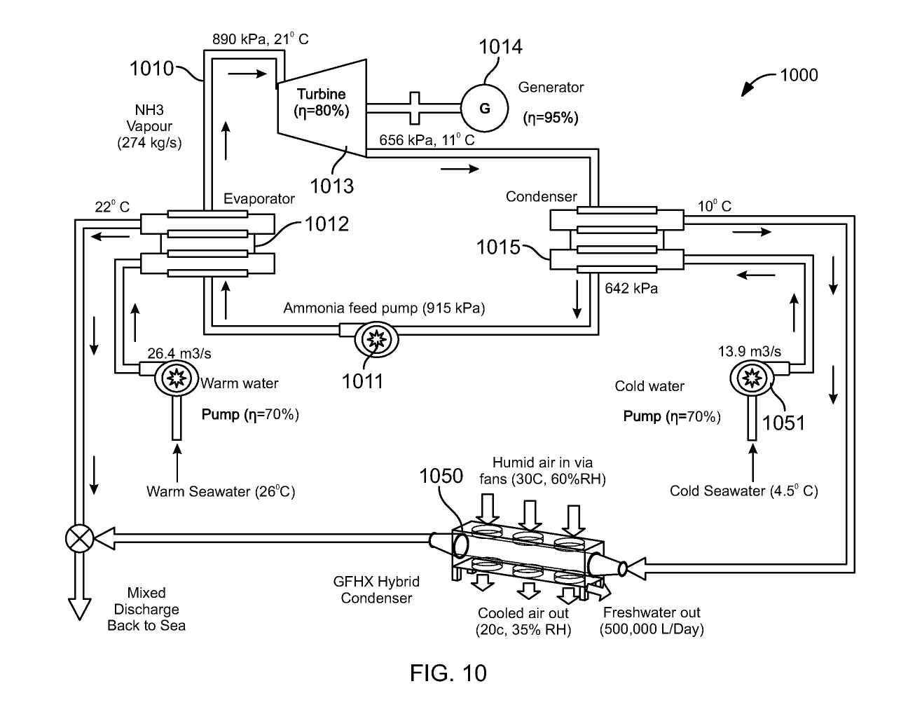

FIG. 10 is a schematic diagram of a closed-cycle Ocean Thermal Energy Conversion (OTEC) system 1000 using a Rankine cycle 1010 to generate electricity which also includes a dewpoint condensation system 1050, according to an example embodiment. The Rankine cycle includes a working fluid pump 1011 to compress ammonia gas into liquid, an evaporator 1012, a turbine 1013 which is turned by ammonia gas, a generator 1014, and a condenser 1015 which removes heat from the ammonia gas. The ammonia gas turns the turbine 1013 which has a rotor portion of an electrical generator 1014 on a common shaft. Thus, as the gas rotates the turbine 1013, it also rotates the rotor of the generator and produces electricity. Cold seawater, is pumped from deep in the ocean (deep seawater) to provide a cooling liquid or refrigerant for condensing the ammonia gas to a liquid at the condenser 1015. The seawater, as shown in the example, is 4.5 degrees Celsius at the input of a pump 1051 which is used to move seawater from a deep sea location to the condenser 1015 of the closed cycle OTEC system 1000. The seawater is heated to 10 degrees Celsius after use in the condenser 1015 of the Rankine cycle 1010. The deep seawater's warmed temperature is still well below the average dewpoint in many tropical locations. As shown, the heated seawater (from the closed-cycle OTEC condenser) is then input to the condenser 1050 where it cools a graphite foam or metal foam fin or graphite foam structure adapted to condense the moisture or water vapor from the ambient humid air in a tropical locale. Thus, a closed-cycle OTEC device is used for power generation and for freshwater generation. The seawater from the condenser of the dewpoint condensation system also warms the seawater. This warmed seawater is mixed with the cooled water from the evaporator 1012 and discharged to the ocean or sea.

Large, low-power, high volume ventilation fans could move the air over banks of graphite foam plate-fins to rapidly condense moisture from the atmosphere. As shown, the condenser 1050 is a single pass, horizontal configuration. It should be noted that multipass or single air input streams, as well as counter-current, co-current and cross-flow HX designs are also contemplated and well within the scope of the invention.

This idea could be implemented as part of a land-based or near-shore OTEC system for Small Island Developing States (SIDS). The example shown is for a 5 MW system is capable of producing 500,000 L/day of freshwater. Larger commercial size units can be envisioned to use the effluent discharge or possible CWP only at 200 m depth. The use of production-grade graphite foam has the potential to be drastically cheaper than the metallic fins/fluted counterparts. Graphite foam is very inert and highly corrosion resistant. In addition, graphite foam can resist temperatures in excess of 2000° C. and can withstand highly acidic chemicals and compounds unlike most metals. Graphite foam is also insoluble in water and is nontoxic so it does not pose a risk to contaminating drinking water the way certain metals (i.e. copper) can.

In some applications a hydrophobic, polymeric, or other coating can be applied to the graphite foam porous structure to increase corrosion resistance, biofouling resistance, and scale formation resistance while maintaining a large thermal advantage over plain tube or metallic plate/fin surfaces.

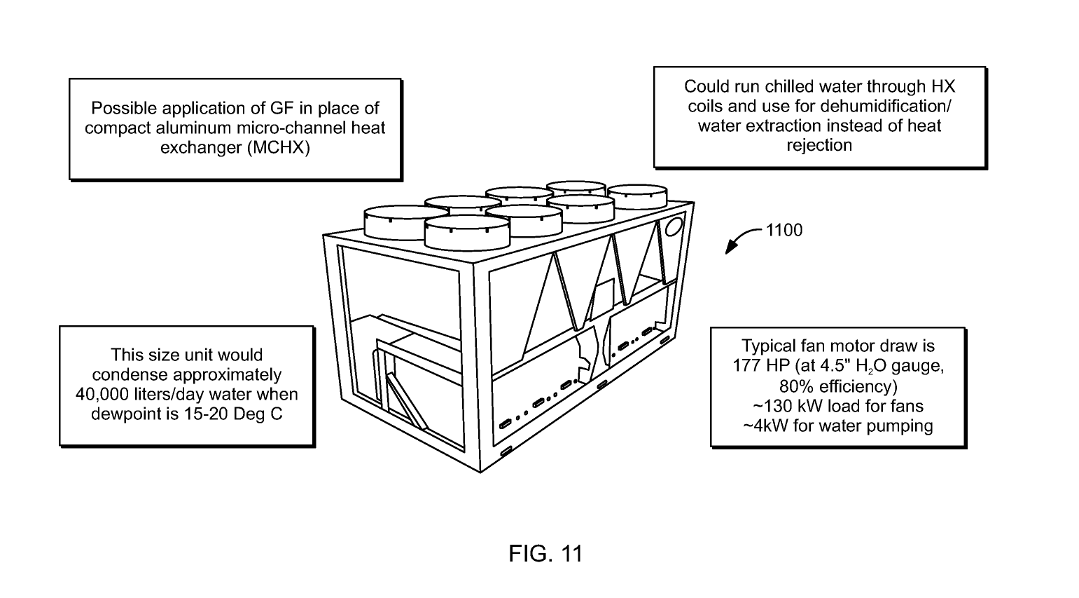

FIG. 11 is a perspective view of a commercial chiller and air conditioning unit 1100, that can be used as a source to cool and condense water from the air in an environment, according to an example embodiment. In the embodiments discussed above, the cold or cool water cools the graphite foam or the fins and graphite foam in the condensers. This provides a cool surface on which the moist air can condense to produce fresh water. It should be noted that cool water or cold ocean water is not the only source of a refrigerant. The same could be provided by a commercial chiller or air conditioning unit 1100 shown in FIG. 11. The refrigerant of the chiller or air conditioner 1100 can cool graphite foam. Warm moist air can be passed through a heat exchanger having graphite foam cooled by the chiller. In essence, the warm air is used to provide heat to the refrigerant in the chiller or is used as part of the evaporator in a Rankine cycle. In one embodiment, graphite foam is added to the commercial AC unit 1100. The graphite foam is used to reject heat for condensation purposes rather than only cooling air.

A condenser includes a circulation system for moving a cooling fluid; and a graphite foam in thermal communication with the circulation system.

A heat exchanger includes a circulation system for moving a cooling fluid through the heat exchanger; and a graphite foam in thermal communication with the circulation system. In one embodiment, the circulation system also includes a multi-hollow extruded (MHE) tubes. The graphite foam is substantially bonded to an exterior surface of the MHE. In one embodiment, the graphite foam is substantially bonded to a majority of the exterior surface of the MHE. The heat exchanger also can include a fluid handling device for moving a cooling fluid through the MHE. The humid air condenses on the exterior surface of the graphite foam to produce substantially desalinated water. The heat exchanger can also include at least one air handling device. The air handling device moves air from an ambient environment into contact with graphite foam. The graphite foam is maintained at a temperature below the dewpoint of the air by way of thermal communication with the cooling fluid. In one embodiment, an air handling unit is used to move air over the graphite foam. An air handling unit is any kind of fan or the like that is used to move air. In another embodiment, the heat exchanger is positioned to capture a prevailing wind. Depending on the amount of wind, the need for a separate air handling unit may be obviated. In another embodiment, The prevailing wind can move the ambient air over the heat exchanger with the assistance of a smaller air handling unit. In this way, the cost of energy associated with the system can be lowered by the amount of energy needed to move air over the graphite. The heat exchanger also includes a shell enclosure. A heat exchanger operating at a low pressure can include a shell made of a fiberglass material. For a higher pressure design, the shell enclosure of the heat exchanger can be made of a metal. Such a metal shell should be designed to meet code or standards set by ASME (American Society of Mechanical Engineers), such as a standard for boilers and other heat exchangers. A metal shell meeting the ASME code or standard generally will not fail due from the operating pressure. In other embodiments, the graphite foam has channels therein for increasing surface area exposed to ambient air or the fluid which will be absorbing heat. The channels also improve fluid management to allow for better draining and collecting of condensed water with minimal pressure drop. In some embodiments, the channels are machined into the graphite foam. The channels can be formed by other means as well. The graphite foam is bonded to condenser tubes with thermally conductive adhesive, in one embodiment. In other embodiments, the graphite foam is bonded to condenser tubes by soldering or by brazing or the like. In some embodiments the graphite foam can be replaced by a metallic foam bonded to the MHEs. In other embodiments, the graphite foam can be replaced by metallic fins adhesively bonded or brazed to the MHEs. In still other embodiments, the graphite foam can be replaced by metallic fins integrally extruded into the shape of the MHEs.

A heat exchanger includes a circulation system for moving a cooling fluid obtained from below a thermocline in the ocean, through the heat exchanger, and a fin structure in thermal communication with the circulation system. The heat exchanger can be used in conjunction with a Closed Cycle Ocean Thermal Energy Conversion system. The heat exchanger uses at least a portion of the Closed Cycle Ocean Thermal Energy Conversion system's expended deep sea cold water as a cooling fluid. In one embodiment, the heat exchanger uses a deep sea cold water source to provide Seawater Air Conditioning (SWAC), and water obtained by dehumidification of air. In one embodiment, the Seawater Air Conditioning and dehumidifier is a standalone system using deep sea cold water from depths of in a range of 150-250 meters below the surface of the ocean. The deep sea cold water from these depths typically has a temperature in a range of 10-15° C. Deep sea cold water having this temperature range will still be satisfactory for producing dehumidified water and cooled air. In some embodiments, an air fin heat exchanger may be used for conventional refrigeration and chiller systems used in households, commercial buildings, and industrial facilities where the recirculated cold refrigerant or chilled water provides the heat sink source for dehumidifying the ambient air. In some embodiments, the circulating fluid can be a cooling fluid other than seawater. For example the cooling fluid can be chiller water, water ethylene glycol mixture, refrigerant, or the like.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A condenser comprising:
a circulation system for moving a cooling fluid; and
a graphite foam in thermal communication with the circulation system.

2. A heat exchanger comprising:
a circulation system for moving a cooling fluid through the heat exchanger; and
a graphite foam in thermal communication with the circulation system.

3. The heat exchanger of claim 2 wherein the circulation system further comprises multi-hollow extruded (MHE) tubes, the graphite foam substantially bonded to an exterior surface of the MHE.

4. The heat exchanger of claim 3 further comprising a fluid handling device for moving a cooling fluid through the MHE, wherein humid air condenses on the exterior surface or the graphite foam to produce substantially desalinated water.

5. The heat exchanger of claim 2 further comprising at least one air handling device for moving air from an ambient environment into contact with graphite foam, the graphite foam maintained at a temperature below the dewpoint of the air by thermal communication with the cooling fluid.

6. The heat exchanger of claim 2 wherein the heat exchanger is positioned to capture a prevailing wind, the wind moving ambient air over the heat exchanger.

7. The heat exchanger of claim 2 further comprising a shell enclosure, the heat exchanger operating at a low pressure so that the shell is made of a fiberglass material.

8. The heat exchanger of claim 2 further comprising a shell enclosure made of a metal to meet ASME code.

9. The heat exchanger of claim 2 wherein the graphite foam has channels therein for increasing surface area.

10. The heat exchanger of claim 2 wherein the graphite foam is bonded to condenser tubes with thermally conductive adhesive.

11. The heat exchanger of claim 2 wherein the graphite foam is bonded to condenser tubes by soldering.

12. The heat exchanger of claim 2 wherein a metallic foam or metallic fins are bonded to the condenser tubes by thermally conductive adhesive, by soldering or by brazing.

13. The heat exchanger of claim 2 wherein metallic fins are extruded integrally with the tubes to enhance heat transfer surface area.

14. A heat exchanger comprising:
a circulation system for moving a cooling fluid obtained from below a thermocline in the ocean, through the heat exchanger; and
a fin structure in thermal communication with the circulation system.

15. The heat exchanger of claim 12 used in conjunction with a Closed Cycle Ocean Thermal Energy Conversion system using at least a portion of the Closed Cycle Ocean Thermal Energy Conversion system's expended deep sea cold water as a cooling fluid.

16. The heat exchanger of claim 12 wherein a deep sea cold water source provides Seawater Air Conditioning (SWAC) and water obtained by dehumidification of air.

17. The heat exchanger of claim 14 wherein, the Seawater Air Conditioning and dehumidifier is a standalone system using deep sea cold water from depths of in a range of 100-150 meters below the surface of the ocean, the deep sea cold water having a typical temperature in a range of 15-20° C.

18. The heat exchanger of claim 14 wherein, the Seawater Air Conditioning and dehumidifier is a standalone system using deep sea cold water from depths of in a range of 150-250 meters below the surface of the ocean, the deep sea cold water having a temperature in a range of 10-15° C.

19. The heat exchanger of claim 14 wherein, the Seawater Air Conditioning and dehumidifier is a standalone system using deep sea cold water from depths of at least 250 meters below the surface of the ocean, the deep sea cold water having a temperature in a range of 4-10° C.

20. An HDH system with a common heat transfer wall that includes graphite foam, the graphite foam on the common wall section between evaporation and condenstation sides to increase heat recovery.

21. A heat hybrid HDH system with Reverse Osmosis (RO) utilizing a carrier gas on the dehumidification side, the HDH system including graphite foam that is bonded to the dehumidifier side to increase heat recovery from the carrier gas in addition to the water vapor supply.

22. The HDH system of claim 21 where the carrier gas is helium.
